(19) United States
(12) Patent Application Publication
(10) Pub. No.: US 2018/0022166 A1
(43) Pub. Date: Jan. 25, 2018

(54) TIRE TREADS HAVING TREAD ELEMENTS WITH INCLINED LATERAL SIDES

(71) Applicant: COMPAGNIE GENERALE DES ETABLISSEMENTS MICHELIN, Clermont-Ferrand (FR)

(72) Inventors: Xavier NEAU, Greenville, SC (US); Francois HOTTEBART, Royat (FR)

(73) Assignees: COMPAGNIE GENERALE DES ETABLISSEMENTS MICHELIN, Clermont-Ferrand (FR); MICHELIN RECHERCHE ET TECHNIQUE S.A., Granges-Paccot (CH)

(21) Appl. No.: 15/523,138

(22) PCT Filed: Oct. 30, 2015
(86) PCT No.: PCT/US2015/058426

§ 371 Date: Apr. 28, 2017

Related U.S. Application Data
(60) Provisional application No. 62/073,784, filed on Oct. 31, 2014.

(51) Int. Cl. B60C 11/03; B60C 19/00; B60C 11/13

(52) U.S. Cl. CPC B60C 11/0309; B60C 11/1323; B60C 19/001; B60C 11/0304; B60C 11/042

(57) ABSTRACT

Tire tread configured to reduce tread wear due to non-zero toe angle alignment and road crown, wherein the tire tread includes intermediate tread elements (28i) having first and second lateral sides (32A, 32B), the first lateral side (32A) extending in a direction of the tread thickness by a first lateral side angle (φ_{A}) relative to a radial reference direction and the second lateral side (32B) extending in a direction of the tread thickness by a second lateral side angle (φ_{B}) relative to a radial reference direction, whereby the tread is characterized in that the average lateral side angle equaling the average angle of all of the first and second lateral side angles for all of the plurality of intermediate tread elements along the length of the tread greater than 3 degrees or less than −3 degrees

This application claims priority to, and the benefit of, U.S. Provisional Patent Application No. 62/073,784 filed on Oct. 31, 2014 with the United States Patent Office, which is hereby incorporated by reference.

### BACKGROUND OF THE INVENTION

### Field of the Invention

This invention relates generally to tire treads having one or more tread elements with inclined laterally-spaced sides, and tires having the same.

### Description of the Related Art

Tire treads are known to include a pattern of voids and/or discontinuities such arranged along a ground-engaging side of the tread to provide sufficient traction and handling during particular conditions. For example, grooves provide voids into which water, mud, or other environmental materials may be diverted to better allow the tread surface to engage a ground surface. By providing the pattern of voids/discontinuities, tread elements are formed along the tread, where the outer portion of said elements are arranged along the outer side of the tread to provide traction as the outer side engages the ground surface (that is, a surface upon with the tire operates, which is also referred to herein as a tire operating surface).

It is well known that the tire tread wears during tire operation due to the generation of slip between the outer side of the tread and the tire operating surface. This not only occurs when the rolling direction of the tire is biased relative to the direction of vehicle travel to generate lateral traction forces, such as when a vehicle is changing direction during turning or cornering maneuvers, but also when the vehicle is traveling in a straight line. Slip will occur due to vehicle toe, that is a toe angle biasing the tire rotational direction slightly from alignment with the straight-line vehicle travel direction. Positive toe, or toe in, is the situation in which the fronts of the wheels angle toward one another. Negative toe, or toe out, is the situation in which the fronts of the wheels angle away from one another. Toe can be utilized to increase straight-line driving stability by introducing opposing forces aligned with the axle on which the tires are mounted. However, because tires operating under toe angles do not rotate in a direction of straight-line vehicle travel, the resulting bias due to toe generates wear on the tire tread.

Slip will also occur due to a crown imparted on a tire operating surface (referred to as road crown), such as a road or ground surface, where the tire operating surface is biased from a level plane by a crown angle, such as when a drop is formed into a road such that the road drops as the road surface extends laterally from a road centerline to a road side. In each of these toe and road crown situations, tire wear results due to the slip imparted on the tire. A known solution to reduce toe-induced wear is to reduce the lateral force generated by the tire at the given toe angle. This solution, however, reduces vehicle stability due to the reduction in lateral force, and heightens the effect of road crown when present. Therefore, when both toe and road crown situations are imparted on a tire at the same instance, there is a desire to provide a solution that reduces the amount of slip and thus wear imposed by each of the toe and road crown, so to increase the usable life of tires.

### SUMMARY OF THE INVENTION

Particular embodiments of the present invention include a tire tread, having a tread length extending in a lengthwise direction normal to a width of the tire tread. The tread further includes a tread thickness extending in a depthwise direction from an outer, ground-engaging side, the depthwise direction extending normal to both the tread width and the tread length. The tread width extends laterally in a direction transverse to the tread thickness and to a length of the tread, the width extending laterally between a first lateral side edge and a second lateral side edge of the tread. The tread further includes a plurality of longitudinal grooves extending in a direction of the tread length, and a plurality of intermediate tread elements offset inwardly from each of the first lateral side edge and the second lateral side edge. The plurality of intermediate tread elements consist of all intermediate tread elements arranged along the tire tread, each intermediate tread element having a first lateral side and a second lateral side each arranged adjacent one of the plurality of longitudinal grooves such that the intermediate tread element is bounded between two of the plurality of longitudinal grooves. The first lateral side extends in a direction of the tread thickness by a first lateral side angle relative to a radial reference direction. The second lateral side extends in a direction of the tread thickness by a second lateral side angle relative to a radial reference direction. The tread is characterized as having an average lateral side angle equaling the average angle of all of the first and second lateral side angles for all of the plurality of intermediate tread elements along the length of the tread, the average lateral side angle being substantially greater than zero or substantially less than zero. In particular variations, the average lateral side angle is greater than or equal to 3 degrees or equal to or less than −3 degrees.

Additional embodiments of the invention include a method for reducing tread wear due to non-zero toe angle alignment and road crown. One step of the method includes providing a single tire, or a first tire and a second tire, where each of the single tire or the first and second tires include any tire tread contemplated above or herein. An additional step includes installing single tire on a vehicle, or installing the first and second tires on a vehicle, the first tire being arranged in a first wheel position and the second tire being arranged in a second wheel position, the first and second wheel positions being arranged on opposing sides of the vehicle such that the first tire is installed in a left or right wheel position and the second tire is installed in the other of the left or right wheel positions and such that both first and second tires are together installed in front or rear wheel positions.

The foregoing and other embodiments, objects, features, and advantages of the invention will be apparent from the following more detailed descriptions of particular embodiments of the invention, as illustrated in the accompanying drawings wherein like reference numbers represent like parts of the invention.

### DETAILED DESCRIPTION OF THE DRAWINGS

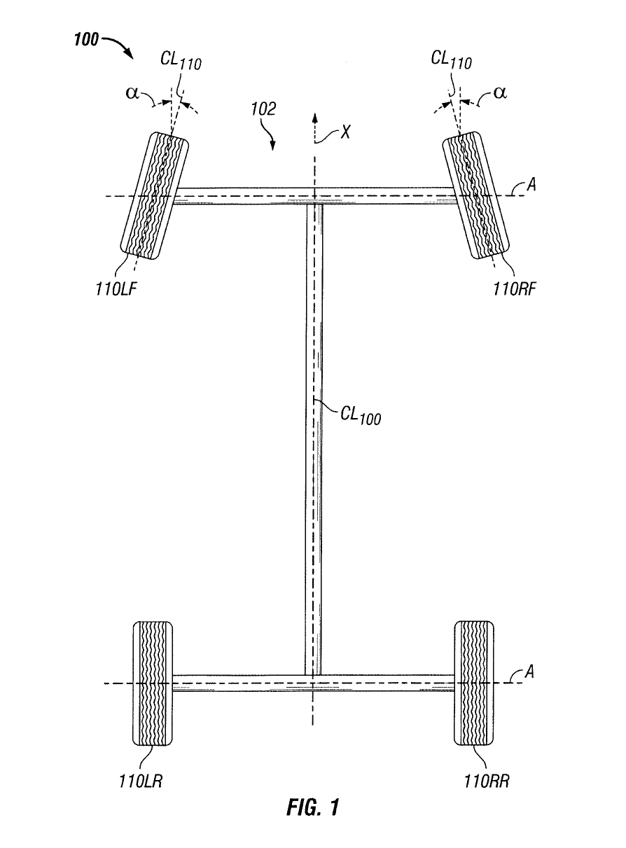

FIG. 1 is a top, partial view of a vehicle, showing the vehicle axles with tires mounted thereon.

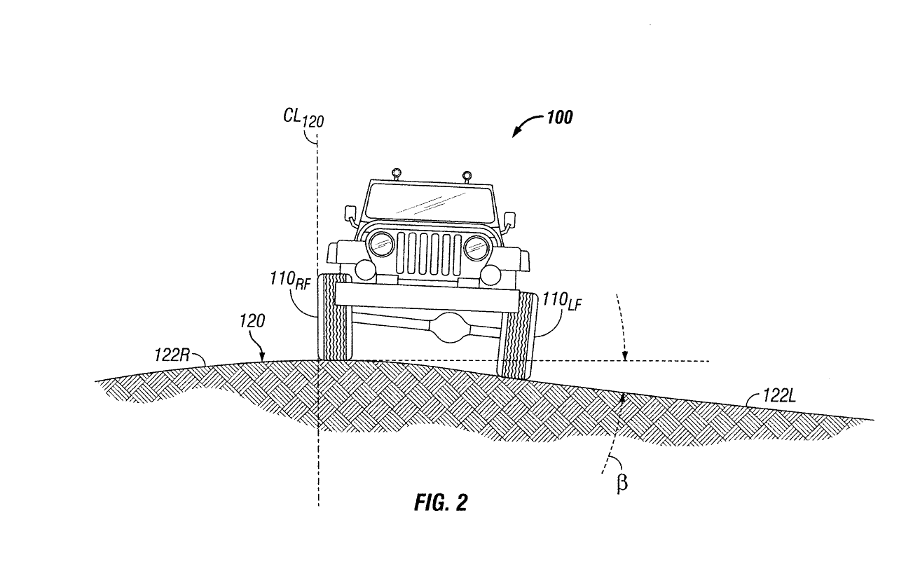

FIG. 2 is a front view of a vehicle travelling along a road surface having a crown.

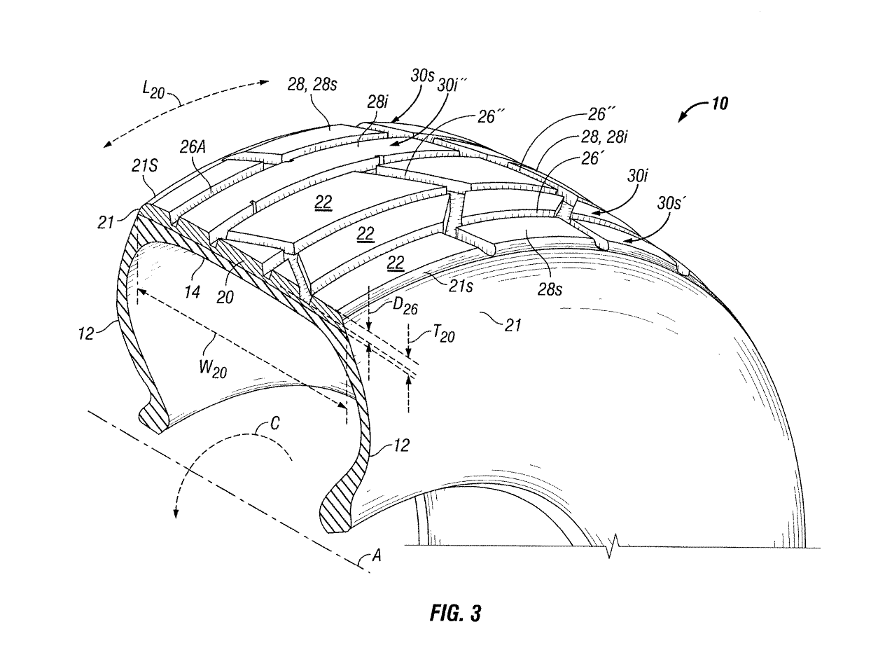

FIG. 3 is a perspective view of a tire, in accordance with an embodiment of the invention.

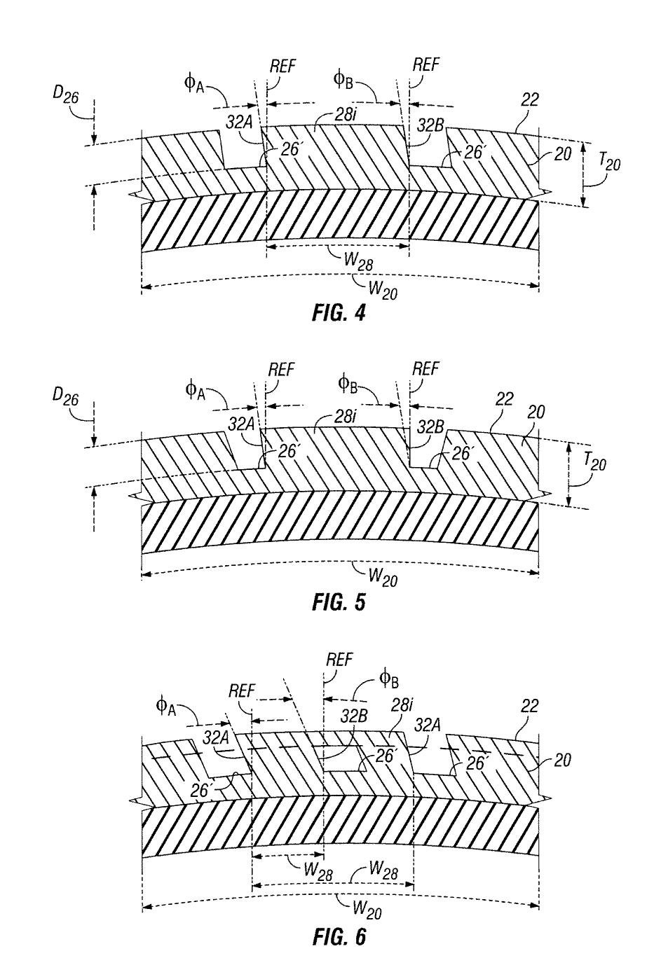

FIG. 4 is a partial, cross-sectional side view of the tire of FIG. 3, in accordance with an embodiment of the invention.

FIG. 5 is a partial, cross-sectional side view of a tire, in accordance with another embodiment of the invention.

FIG. 6 is a partial, cross-sectional side view of a tire, in accordance with another embodiment of the invention.

### DETAILED DESCRIPTION OF PARTICULAR EMBODIMENTS

Particular embodiments of the invention described herein provide a tire tread exhibiting improved wear characteristics, and in particular embodiments annular pneumatic tires including such tire treads. Additional embodiments include methods for reducing tread wear due to non-zero toe angle alignment and road crown.

As noted above, slip between the tire tread and the tire operating surface generates tread wear. A tire footprint is described as a portion of the tire tread that contacts the tire operating surface (which is a surface upon which a tire operations, such as the ground or a road surface, for example) during tire operation. A footprint is also referred to as a “contact area” or “contact patch.” As noted above, slip can occur between a tire and a tire operating surface even when the vehicle is traveling in a straight-line direction, that is, when the vehicle is traveling along a non-cornering path. This can occur, for example, when the rotational direction of the tire is biased by a toe angle relative to a straight-line travel direction for the vehicle, or, in other words, relative to a longitudinal centerline of the vehicle, spaced equally between left and right side tires. Toe is briefly described in association with FIG. 1, where an overhead view of an axle system 102 of a vehicle 100 is shown. In particular, opposing left and right front tires 110LF, 110RF are shown in association with an axle 114 and a longitudinal centerline CL₁₀₀, which also indicates a direction of straight-line vehicle travel X. Relative to the longitudinal centerline CL₁₀₀ of the vehicle and the direction of straight-line travel X, each opposing front tire 110LF, 110RF is arranged in a toe-in configuration, where the longitudinal centerline CL₁₁₀ of each tire extending in a direction of forward travel is biased by a positive toe angle α. Biasing each front tire with a positive toe is often employed to force a vehicle into a straight-line direction. The rear tires 110LR, 110RR are shown to have no toe, that is, the longitudinal centerline of each is parallel to the longitudinal centerline of the vehicle. Opposing left and right wheel positions for the front or rear can be said to be arranged along a common mounting axis or common axle 114 of the vehicle. A common axle refers to a front or rear axle, where the axle defines a common mounting axis extending across the vehicle (such as substantially perpendicular to the longitudinal vehicle centerline) to and between opposing left and right wheel positions. One of ordinary skill will appreciate that a common axle, as used herein, may comprise separate or independent left and right axles or a solid axle configured to rotate both left and right wheel positions. A common mounting axis or axle may also comprise a common rotational axis of both associated left and right wheel positions.

By further example, straight-line slip can occur when the tire operating surface is sloped in a direction transverse to the straight-line direction of travel for the vehicle. This commonly occurs on road surfaces, where the road is sloped downward from the road centerline to each of the opposing sides defining a width of the road. Road crown is employed to better allow water to drain to the sides of a road, for the purpose of reducing the standing of water along the road and therefore reducing the occurrence of hydroplaning. Road crown is briefly described in association with FIG. 2, where a front view of a vehicle 100 is shown. In particular, vehicle 100 is shown along a tire operating surface 120 comprising a road or road surface, where the road surface has a crown. The crown is represented, in this exemplary embodiment, by first and second sides 122L, 122R of the road downwardly sloping from a center CL₁₂₀ of the road and towards a widthwise or outward side of the road by an angle β.

In each of these toe and crown situations, tire wear results due to slip imparted on the tire when the vehicle maintains a straight-line direction of travel. By virtue of employing the inventive tread features described herein, which includes selectively inclining one or both opposing lateral sides defining a width of a tread element, which is referred to herein as an “average lateral side angle” for all intermediate tread elements, a lateral thrust is generated when the tire is simply loaded, where this lateral thrust has been found to improve tread wear performance on opposing left and/or right wheel position tires exposed to both toe and road crown inputs. Because this lateral thrust is generated as the tire is loaded, the thrust will not generate any significant wear, unlike the lateral thrust generated by the rolling mechanics of the tire, such as due to camber, toe, or steering inputs, for example (creating a drift angle). This lateral thrust improves tread wear performance on opposing left and/or right wheel position tires based upon simulations conducted, where in such simulations, the tires are exposed to both toe and road crown inputs. For a given tread design, a specific lateral thrust (both in direction and magnitude) may be employed to improve tread wear for each uphill and downhill tire for each axle of any vehicle.

For a given tire tread design, for a given vehicle and tire orientation (front toe and rear toe), and for a given road network (actual or average road crown), there is for each vehicle wheel position an optimum average lateral side angle that more precisely reduces wear at each given position. One manner for determining this optimum average lateral side angle for each wheel position is to use a tire model coupled to a vehicle model and a road model. An alternative way is to use an experimental approach by conducting various tire wear tests on a vehicle using different tread designs, such as, for example using tires each having an average lateral side angle equal to −12 degrees, 0 degrees, +12 degrees. Using more advanced technique, we can optimize vehicle wear for several different scenarios: (1) 1 tire design per vehicle position (so 4 different tire designs in the case of a regular passenger car); (2) 1 tire design per axle (so 2 different tire designs in the case of a regular passenger car); (3) 1 tire design per vehicle with asymmetric mounting, where the left and right tires rotate in different directions; and (4) 1 tire design per vehicle with directional mounting, where the left and tires rotate in the same direction. For scenario (3) above, the average lateral side angle of the right tire is equal to the opposite (+ or −) of the average lateral side angle of the left tire, where the average lateral side angle for the left tire equals −1 multiplied by average lateral side angle of the right tire (or vice versa). For scenario (4) above, the average lateral side angle of the right tire is equal to the average lateral side angle of the left tire.

As noted above, various embodiments of the invention include a tire tread. The tire tread has a length and a width, the length extending in a lengthwise direction normal to a widthwise direction, which is the direction by which the tread width extends. When the tread is attached to a tire, the tread length extends circumferentially around a circumference of the tire. The tire tread also has a thickness extending in a depthwise direction from an outer, ground-engaging side of the tread. When the tire tread is attached to a tire, the depthwise direction is a radial direction normal to the outer, ground-engaging side and normal to both the width and length of the tread. The tread width extends laterally in a direction transverse to the tread thickness and to a length of the tread, the width extending laterally between a first lateral side edge and a second lateral side edge of the tread.

It is further noted that embodiments of such treads include a plurality of longitudinal grooves and a plurality of tread elements comprising intermediate tread elements. The plurality of intermediate tread elements are offset inwardly from each of the first lateral side edge and the second lateral side edge. This means that the plurality of intermediate tread elements are arranged laterally inward from, or between, one or more shoulder tread elements, where shoulder tread elements are tread elements arranged adjacent the or closest to each of the first and second lateral tread edges.

Each intermediate tread element has a first lateral side and a second lateral side. Each of the first and second lateral sides are formed by being arranged adjacent one of the plurality of longitudinal grooves such that the intermediate tread element is bounded between two of the plurality of longitudinal grooves. Therefore, it can be said that the two of the plurality of longitudinal grooves are spaced apart in the direction of the tread width by an intermediate tread element width. In other embodiments, sipes or other discontinuities may be substituted from longitudinal grooves. It is noted that each of the opposing lateral sides of the intermediate tread element extend in both a direction of the tread thickness and in a direction of the tread length, where the opposing lateral sides are spaced-apart to form a width of the intermediate tread element.

With further regard to each intermediate tread element, the first lateral side can be described as extending in a direction of the tread thickness by a first lateral side angle relative to a radial reference direction, and the second lateral side described as extending in a direction of the tread thickness by a second lateral side angle relative to a radial reference direction. To improve the wear performance of the tire tread when a tire is operating under conditions of both toe and road crown, one or both of the first and second lateral sides may be sufficiently inclined, such that, when considering all the intermediate tread elements of a tread, the tread is characterized as having an average lateral side angle equaling the average angle of all of the first and second lateral side angles for all of the plurality of intermediate tread elements along the length of the tread, the average lateral side angle being substantially non-zero, which, in particular embodiments, is greater than or equal to 3 degrees or equal to or less than −3 degrees. In other embodiments, the average lateral side angle is greater than or equal to 5 degrees or equal to or less than −5 degrees. In still other embodiments, the average lateral side angle is greater than or equal to 10 degrees or equal to or less than −10 degrees, or greater than or equal to 12 degrees or equal to or less than −12 degrees. By doing so, a lateral thrust is generated to overcome the combined effects of toe and road crown.

It is appreciated that in generating the inclinations described in the prior paragraph, and elsewhere herein, the first and second lateral sides for any and all intermediate tread elements may be the same or different inclination. For example, for at least one of the intermediate tread elements, the first lateral side angle is substantially equal to the second lateral side angle. By further example, for at least one of the intermediate tread elements, the first lateral side angle is greater than or less than the second lateral side angle.

It is also appreciated that any first or second lateral side of an intermediate tread element may be planar or non-planar. In being non-planar, it is appreciated that any such lateral side may include nonlinearities, undulations, or other features resulting in a non-planar side. Accordingly, in particular embodiments, where the first lateral side for at least one of the plurality of intermediate tread elements is non-planar, the first lateral side angle is an effective first side angle equaling an average of the first lateral side angle taken along a full length of the first lateral side of the at least one of the plurality of intermediate tread elements. In further embodiments, in addition, where the second lateral side for at least one of the plurality of intermediate tread elements is non-planar, the second lateral side angle is an effective second side angle equaling an average of the second lateral side angle taken along a full length of the second lateral side of the at least one of the plurality of intermediate tread elements.

A tread element, as used herein, such as when referring to an intermediate or shoulder tread element, refers to a tread block (that is, lug) or a tread rib, where the width of the tread element is defined by a pair of discontinuities spaced-apart in a direction of the tread width, where one of the pair of discontinuities is arranged along one of the opposing lateral sides and the other of the pair of discontinuities is arranged along the other of the opposing lateral sides of the tread element. Each discontinuity of the pair of discontinuities may comprise any desired discontinuity, such as a sipe or a groove as noted above, for example. Any discontinuity may extend partially or fully along the length of the tread. In particular embodiments, the tread element forms a continuous rib, the rib comprising a single tread element (and therefore the rib) extending the full length or substantially the full length of the tread, whereby the tread element length (and therefore the rib length) extends in a direction of the tread length (a longitudinal direction of the tread), such that when the tread is arranged around a tire, the rib is arranged in a circumferential direction of the tire. In other embodiments, in lieu of the tread rib comprising a continuous rib, a plurality of tread elements (such as a quantity of a plurality of intermediate tread elements) are spaced apart in the lengthwise direction of the tread to form a discontinuous rib. For any rib, the rib length may extend along a linear path (prior to installation on a tire, such as a retread), a constant radius curvilinear path (where the path extends in one direction around a tire), or an undulating non-linear path, which is a laterally undulating path (that is, where the path alternates back and forth in a direction of the tread width as the path extends in a direction of the tread length).

As mentioned above, a discontinuity may comprise a sipe or a groove. A sipe comprises a slit or laceration, or a narrow groove generally having a molded void width or thickness up to 1.2 millimeters (mm) or otherwise configured, such that opposing sides of the sipe defining the sipe width or thickness contact or close during tire operation, such as when the sipe is arranged within a tire footprint. A groove has a width or thickness greater than that of a sipe, and is configured to remain open during tire operation, such as when the groove is arranged within a tire footprint to receive and evacuate water, snow, mud, or other environmental materials through which the tire is traveling.

It is appreciated that any discontinuity extends into the tread thickness by any desired depth to sufficiently form a first or second lateral side of a tread element, but generally at least 2 mm in particular embodiments. The discontinuity also has a length extending at least partially in a direction of a tread length, and partially or fully across the length of any tread element. It is appreciated that the length of the discontinuity may extend entirely or partially in the direction of the tread length (that is, in a direction normal to the tread width). When extending partially in the direction of the tread length, the length of the discontinuity extends in both the direction of the tread length and the direction of the tread width, such that the discontinuity length extends along a path having a vector extending in a direction of the tread length and a vector extending in a direction of the tread width. It is also appreciated that the length of the discontinuity may extend along any desired path, whether a linear or non-linear path. A non-linear path includes curvilinear and undulating paths. An undulating path extends back and forth, in an alternating manner, whether in linear or non-linear paths.

It is appreciated that any tread discussed herein may be arranged along an annular pneumatic tire, or may be formed separately from a tire as a tire component for later installation on a tire carcass, in accordance with any technique or process known to one of ordinary skill in the art. For example, the treads discussed and referenced herein may be molded with a new, original tire, or may be formed as a retread for later installation upon a used tire carcass during retreading operations. Therefore, when referencing the tire tread, a longitudinal direction of the tire tread is synonymous with a circumferential direction of the tire when the tread is installed on a tire. Likewise, a direction of the tread width is synonymous with an axial direction of the tire or a direction of the tire width when the tread is installed on a tire. Finally, a direction of the tread thickness is synonymous with a radial direction of the tire when the tread is installed on a tire. It is understood that the inventive tread may be employed by any known tire, which may comprise a pneumatic or non-pneumatic tire, for example.

It is appreciated that any of the tread features discussed herein may be formed into a tire tread by any desired method, which may comprise any manual or automated process. For example, the treads may be molded, where any or all discontinuities therein may be molded with the tread or later cut into the tread using any manual or automated process. It is also appreciated that any one or both of the pair of opposing discontinuities may be originally formed along, and in fluid communication with, the outer, ground-engaging side of the tread, or may be submerged below the outer, ground-engaging side of the tread, to later form a tread element after a thickness of the tread has been worn or otherwise removed during the life of the tire.

By incorporating the one or more inclined lateral sides as described herein, when any such tire operates with a non-zero toe angle and along a laterally-inclined road surface (“crowned road surface”), the tread wear rate and/or irregular wear is reduced. Irregular wear connotes a tire tread characterized as having non-uniform or uneven wear across a width and/or length of the tread.

It is further noted that it has been determined that, for a pair of opposing tires arranged on opposing lateral sides of a vehicle, that is, stated differently, on opposing sides of a vehicle longitudinal centerline, such as along a common rotational axis, each of the pair of opposing tires incur different slip and therefore different wear rates when the vehicle operates along a crowned or inclined tire operating at the same toe angle. In such instances, one of the tires (a first tire) of the pair of opposing tires is arranged uphill along the crowned tire operating surface relative to the other tire (a second tire) of the pair of opposing tires, which is arranged downhill relative the first tire. As a result, it has been found that, in at least a majority of the cases, the downhill tire wears more, or at a higher rate, than the uphill tire in situations where both left and right tires are orientated with positive toe. For example, with reference to FIG. 2, left front tire 110_{LF} is a downhill tire located downhill relative to the right front tire 110_{RF} (an uphill tire) along a crowned or inclined tire operating surface 122L. In this scenario, the downhill tire (left front tire 110_{LF}) experiences more wear, or wears at a higher wear rate, relative the uphill tire (right front tire 110_{RF}) due to the combined effects of positive toe and road crown. Because it has been found that the combined effects of toe and road crown impact left and right wheel position tires differently, it is appreciated that differently designed tires, or tires of the same design mounted to rotate in the same or opposing directions, may be used on opposing left and right wheel positions of a vehicle to reduce the effects of road crown and toe acting separately or independently on each opposing left and right wheel position. For example, in one scenario, left and right tires have different designs, which allows for independent optimization to improve tread wear for each separate wheel position. By further example, in another scenario, the same tire design is used for both left and right wheel positions, except that the tires are mounted to rotate in opposing directions, which has been shown to work best to improve tire wear resulting from the effects of toe. The use of tires of a common tire design, mounted to rotate in opposite directions between opposing left and right wheel positions, is referred to within the industry as asymmetric tire mounting. In yet another example, in another scenario, the same tire design is used for both left and right wheel positions, except that the tires are mounted to rotate in the same direction, which has been shown to work best to improve tire wear resulting from the effects of road crown. The use of a single tire design for both opposing left and right wheel positions, where the tire is mounted to rotate in the same direction relative the tread design regardless of wheel position, is referred to within the industry as directional tire mounting.

Accordingly, particular embodiments of the invention comprise methods for reducing tread wear due to non-zero toe angle alignment and road crown. One step includes providing one or a pair of tires, each having a tread, which may comprise any tire tread described or contemplated herein, the tread being characterized as having an average lateral side angle equaling the average angle of all of the first and second lateral side angles for all of the plurality of intermediate tread elements along the length of the tread, the average lateral side angle being substantially greater than zero or substantially less than zero (that is, substantially non-zero). In particular embodiments of the method, the average lateral side angle of the first tire is different than the average lateral side angle of the second tire. In other embodiments of such methods, the average lateral side angle of the first tire is substantially opposite in value than the average lateral side angle of the second tire. In any embodiment of the methods, in specific instances, both the first and second tires are arranged relative to the vehicle to have a non-zero toe angle and where the vehicle is translating along an inclined road surface such that the second tire is arranged at a lower elevation relative the first tire along the inclined road surface. In certain variations of such methods, the non-zero toe angle is a positive toe angle, although the non-zero may instead be a negative toe angle.

Particular embodiments of the tire treads, tires, and methods discussed above will now be described in further detail below in association with the figures filed herewith exemplifying the performance of the methods in association with particular embodiments of the tires.

With reference to FIGS. 3 and 4, a tire 10 according to an exemplary embodiment of the present invention is shown. The tire 10 comprises a pneumatic tire having a pair of sidewalls 12 each extending radially outward from a rotational axis A of the tire to a central portion 14 of the tire 10. The central portion 14 of the tire is annular in shape, and includes a tread 20 having a thickness T₂₀ extending in a radial direction of the tire (relative a rotational axis of the tire) from an outer, ground-engaging side 22 of the tread to a bottom side 24 for attachment and bonding to the tire. The tread also has a width W₂₀ extending in a lateral direction (“laterally”) between the pair of opposing, lateral side edges 21 comprising a first lateral side edge and a second lateral side edge of the tread each arranged adjacent to one of the sidewalls 12. It can be said that the pair of sidewalls 12 comprise a first sidewall and a second sidewall each extending radially inward from one of a pair of shoulders 21_{S} proximate to one of the first lateral side edge and the second lateral side edge. The tread also has a length L₂₀ extending circumferentially around the tire. It can be said that the width extends laterally in a widthwise direction transverse to the tread thickness T₂₀ and to a length L₂₀ of the tread, which can be said to extend longitudinally in a circumferential direction of the tire. In summary, the tread has a length, a width, and a tread thickness, the thickness extending inward from an outer, ground-engaging side in a direction normal to both the width and length of the tread, which is also referred to as a depthwise direction of the tread. The tread also includes a pair of shoulders 21_{S} forming a transition between the outer, ground-engaging side 22 and each lateral side edge 21 of the tread 20. While the tread is shown to form a portion of a tire, in other embodiments, the tread may be separate from the tire, such as when the tread is formed prior to being applied to a tire during retreading operations.

With regard to the ground-engaging side 22 of the tread 20, the tread shown in FIGS. 3 and 4 to include a plurality of discontinuities 26′, 26″. In the embodiment shown, discontinuities 26 comprise voids each forming a groove. Moreover, discontinuities 26′ comprise longitudinal grooves having a length extending in a direction of the tread length, which in certain embodiments is in a circumferential direction of the tire, while discontinuities 26″ comprise lateral grooves and lateral sipes, respectively, each having a length extending in a direction of the tread width W₂₀, which is in an axial direction A of the tire. Each discontinuity also has a depth D₂₆ extending into the tread thickness T₂₀ from the outer, ground-engaging side 22, which is also shown to be in a radial direction of the tire. It is appreciated that, in particular embodiments, such as is shown in one exemplary embodiment in FIG. 6, the outer, ground engaging side 22 from which any discontinuity extends may exist or arise only after a thickness of the tread has been worn to reach or expose a submerged discontinuity 26′. A submerged discontinuity may comprise any discontinuity contemplated herein, including a groove or a sipe, for example.

As shown in FIGS. 3-6, the plurality of discontinuities define a plurality of tread elements. In the embodiment shown in FIGS. 4-6, each of the one or more intermediate tread elements 28i have a width arranged between a pair of longitudinal discontinuities 26′ extending in a direction of the tread length L₂₀. In the embodiment shown, the pair of discontinuities 26′ comprise a pair of longitudinal grooves, but may comprise any discontinuity contemplated herein. In any event, one of the pair of discontinuities 26′, which is also referred to as a first discontinuity, is arranged adjacent to a first lateral side 32A of the tread element, while the other of the pair of discontinuities 26′, which may be referred to as a second discontinuity, is arranged adjacent to the a second lateral side 32B of the tread element such that the pair of discontinuities and the first and second lateral sides of the tread element are spaced-apart in a direction of the tread width W₂₀ to define a width W₂₈ of the tread element.

In the embodiment shown in FIG. 3, a plurality of tread elements 28 comprise a plurality of shoulder tread elements 28s and a plurality of intermediate tread elements 28i. The plurality of shoulder tread elements 28s comprise one or more first shoulder tread elements arranged along the first lateral side edge 21 of the tread and one or more second shoulder tread elements arranged along the second lateral side edge 21 of the tread. The plurality of intermediate tread elements 28i are arranged or spaced-apart laterally (that is, in a direction of the tread width) between the first and second shoulder tread elements 28s, where the plurality of intermediate tread elements are offset from each of the first and second lateral side edges 21.

In the particular embodiment shown in FIG. 3, the plurality of tread elements include a continuous rib 30i″ while a quantity of the plurality of tread elements are arranged in a spaced-apart arrangement to form each of several discontinuous ribs 30i′, 30s′. Specifically, a quantity of intermediate tread elements 28i are arranged a direction of the tread length L₂₀ to form each intermediate discontinuous rib 30i′, while a quantity of shoulder tread elements 28s are arranged in a direction of the tread length L₂₀ to form each of the shoulder discontinuous ribs 30s′. When the tread is arranged on a tire 10, extending in a direction of the tread length may provide a rib extending in a circumferential direction C of the tire or in a direction biased thereto in a lateral direction. In particular embodiments, a discontinuous rib can be described as an array or series of tread elements arranged in a direction of the tread length. It is appreciated that a rib may comprise any known rib. For example, a rib may extend partially or fully along the length of the tread, and may extend partially or fully in the direction of the tread length, such that, in particular embodiments a rib extends annularly around the tire. By further example, a rib may be said to have a length extending in a direction of the tread length, where the rib extends along a linear path, or a constant radius curvilinear path when arranged along tire, or an undulating non-linear path alternating back and forth in alternating directions of the tread width.

With continued reference to the embodiment in FIG. 3, the tread elements 28 are arranged into one of five (5) different ribs comprising shoulder ribs 30s and intermediate ribs 30i′, 30″. Each of the pair of shoulder ribs 30s′ are bounded by a lateral side edge 21 of the tread width W₂₀ and a longitudinal discontinuity 26′, which comprises a longitudinal groove in the embodiment shown. Intermediate ribs 30i′, 30i″ are bounded on both lateral sides by a pair of spaced-apart longitudinal discontinuities 26′, which comprise longitudinal grooves or sipes in the embodiment shown. While FIG. 3 illustrates a 5-rib tire, it is to be appreciated that the methods described herein can be utilized with tires having more or less ribs than tire 10.

With reference the embodiment shown in FIGS. 4-6, for each intermediate tread element 28i, both the first and second lateral sides 32A, 32B extend in a direction of the tread thickness T₂₀, where, for each of the one or more intermediate tread elements 28i, the first lateral side 32A is oriented at a first lateral side angle φ_{A} (inclination angle) relative to the depthwise direction of the tread (that is, in a direction of the tread thickness) and the second lateral side 32B is oriented at a second lateral side angle φ_{B} (inclination angle) relative to the depthwise direction of the tread. These first-side and second-side angles φ_{A}, φ_{B} are each taken as an average of the corresponding angle over the full height H₃₂ of the corresponding first and second lateral side 32A, 32B along the full length L₃₂ of the corresponding first and second lateral side for a tread element. It is further noted that a positive average first lateral side angle φ_{A} orientation and a positive second lateral side angle φ_{B} orientation are provided when the respective first lateral side 32A and the second lateral side 32B are each increasingly inclined towards a one of the side edges 21 in a direction of the tread width W₂₀ as each respective first lateral side and second lateral side extend in a direction of the tread thickness towards the outer, ground-engaging side of the tread. For example, in certain instances, this direction of inclination directed to one of the opposing side edges 21 is directed toward an inside of the vehicle, that is, toward the tread side edge 21 closest to the vehicle centerline CL₁₀₀. It is contemplated that, in providing a positive or negative average angle, a portion of the first or second side may include a negative or positive angle so long as the average angle for each side is positive or negative, respectively It is appreciated that, for any configuration described herein, in particular embodiments, the average first lateral side angle may be different than the average second lateral side angle, or, in other embodiments the average first lateral side angle may be substantially equal to the average second lateral side angle.

In particular embodiments, with reference to FIGS. 4-6, to quantify an overall positive inclination of the first and second lateral sides 32A, 32B, an average lateral inclination angle (also referred to as an “average lateral side angle”) comprising an average of both the first lateral side angle φ_{A} and the second lateral side angle φ_{B} for all of the one or more intermediate tread elements 28i along the first and second lateral sides is provided, where the average lateral inclination angle is substantially greater than zero or substantially less than zero to provide improved tread wear characteristics as described herein. The average lateral side angle is not solely the average of only the first-side angle for all of the one or more intermediate tread elements or the average of only the second side angle for all of the one or more intermediate tread elements. Instead, it is the combined average of the first side and second-side angles for all first and second lateral sides for all of the one or more intermediate tread elements, taken along the full height and length of each first and second lateral sides of all intermediate tread elements for the full length of the tread. It is appreciated that any one of the first lateral side angle φ_{A} and the second lateral side angle φ_{B} may be zero or negative so long as the average inclination angle is positive and substantially greater than zero, or, in the alternative, may be zero or positive so long as the average lateral side angle is negative and substantially less than zero. For example, while in each embodiment shown in

FIG. 4-6 the average lateral side angle is substantially non-zero for all intermediate tread elements, in FIGS. 4 and 6, both φ_{A} and φ_{B} are substantially non-zero (positive or negative) while in FIG. 5, φ_{A} is non-zero and φ_{B} is zero. In other embodiments, while providing an average lateral side angle that is substantially non-zero, it is appreciated that the first lateral side angle φ_{A} may be negative or positive while the second lateral side angle φ_{B} is the other of negative or positive. Therefore, in particular embodiments, it is appreciated that both the average first lateral side angle φ_{A} and the average second lateral side angle φ_{B} are substantially greater than zero or substantially less than zero, for the substantial length of each first and second side, respectively. In particular embodiments, the average inclination angle is an average for all of the tread elements arranged long a tire tread, that is both shoulder and intermediate tread elements.

In particular embodiments, for any of the first lateral side angle, the second-side angle, and the average lateral side angle for all intermediate tread elements, as described previously in different embodiments, substantially non-zero means substantially equal to ±3 degrees or more, ±5 degrees or more, ±10 degrees or more, ±12 degrees or more, ±3 to ±30 degrees, or ±10 to ±30 degrees.

It is further noted, because it has been determined that, for a pair of opposing tires arranged on opposing lateral sides of a vehicle, each of the pair of opposing tires incur different slip and therefore different wear rates when the vehicle operates along a crowned or inclined tire operating at the same toe angle, where one of the pair of opposing tires is arranged uphill relative to the other of the pair of opposing tires arranged downhill along the crowned tire operating surface. It is also appreciated that, in certain instances, opposing tires have tread elements having differently inclined opposing lateral sides, that is, the inclination of the opposing lateral sides for the one or more tread elements on one of the opposing tires is different than the inclination of the opposing lateral sides for the one or more tread elements on the other of the opposing tires.

The terms “comprising,” “including,” and “having,” as used in the claims and specification herein, shall be considered as indicating an open group that may include other elements not specified. The terms “a,” “an,” and the singular forms of words shall be taken to include the plural form of the same words, such that the terms mean that one or more of something is provided. The terms “at least one” and “one or more” are used interchangeably. The term “single” shall be used to indicate that one and only one of something is intended. Similarly, other specific integer values, such as “two,” are used when a specific number of things is intended. The terms “preferably,” “preferred,” “prefer,” “optionally,” “may,” and similar terms are used to indicate that an item, condition or step being referred to is an optional (i.e., not required) feature of the invention. Ranges that are described as being “between a and b” are inclusive of the values for “a” and “b” unless otherwise specified.

While this invention has been described with reference to particular embodiments thereof, it shall be understood that such description is by way of illustration only and should not be construed as limiting the scope of the claimed invention. Accordingly, the scope and content of the invention are to be defined only by the terms of the following claims. Furthermore, it is understood that the features of any specific embodiment discussed herein may be combined with one or more features of any one or more embodiments otherwise discussed or contemplated herein unless otherwise stated.

1. A tire tread comprising:
a tread length extending in a lengthwise direction normal to a width of the tire tread;
a tread thickness extending in a depthwise direction from an outer, ground-engaging side, the depthwise direction extending normal to both the tread width and the tread length, and
the tread width extending laterally in a direction transverse to the tread thickness and to a length of the tread, the width extending laterally between a first lateral side edge and a second lateral side edge of the tread;
a plurality of longitudinal grooves extending in a direction of the tread length;
a plurality of intermediate tread elements offset inwardly from each of the first lateral side edge and the second lateral side edge, the plurality of intermediate tread elements consisting of all intermediate tread elements arranged along the tire tread, each intermediate tread element having a first lateral side and a second lateral side each arranged adjacent one of the plurality of longitudinal grooves such that the intermediate tread element is bounded between two of the plurality of longitudinal grooves,
the first lateral side extending in a direction of the tread thickness by a first lateral side angle relative to a radial reference direction;
the second lateral side extending in a direction of the tread thickness by a second lateral side angle relative to a radial reference direction,
where the tread is characterized as having an average lateral side angle equaling the average angle of all of the first and second lateral side angles for all of the plurality of intermediate tread elements along the length of the tread, the average lateral side angle being greater than or equal to 3 degrees or equal to or less than −3 degrees; and
where the average lateral side angle for each of the first lateral side and for the second lateral side is non-zero for all intermediate tread elements.

2. The tire tread of claim 1, where the first lateral side for at least one of the plurality of intermediate tread elements is non-planar, where the first lateral side angle is an effective first side angle equaling an average of the first lateral side angle taken along a full length of the first lateral side of the at least one of the plurality of intermediate tread elements.

3. The tire tread of claim 1, where the first lateral side for at least one of the plurality of intermediate tread elements is planar.

4. The tire tread of claim 2, where the second lateral side for at least one of the plurality of intermediate tread elements is non-planar, where the second lateral side angle is an effective second side angle equaling an average of the second lateral side angle taken along a full length of the second lateral side of the at least one of the plurality of intermediate tread elements.

5. The tire tread of claim 1, where at least one of the plurality of longitudinal grooves extend continuously along the length of the tread.

6. The tire tread of claim 1, where the two of the plurality of longitudinal grooves are spaced apart in the direction of the tread width by an intermediate tread element width.

7. The tire tread of claim 1, where at least one of the plurality of intermediate tread elements is a continuous rib extending along the length of the tire tread.

8. The tire tread of claim 1, where a quantity of the plurality of intermediate tread elements are arranged to form a discontinuous rib extending along the length of the tire tread.

9. The tire tread of claim 1, where at least a quantity of the intermediate tread elements form a tread block.

10. (canceled)

11. The tire tread of claim 1, wherein for at least one of the intermediate tread elements, the first lateral side angle is substantially equal to the second lateral side angle.

12. The tire tread of claim 1, wherein the first lateral side angle is greater than or less than the second lateral side angle.

13. The tire tread of claim 1, where the average lateral side angle is greater than or equal to 5 degrees or equal to or less than −5 degrees.

14. The tire tread of claim 1, where the average lateral side angle is greater than or equal to 10 degrees or equal to or less than −10 degrees, or is greater than or equal to 12 degrees or equal to or less than −12 degrees.

15. (canceled)

16. A method for reducing tread wear due to non-zero toe angle alignment and road crown, the comprising:
providing a first tire and a second tire, each of the first and second tires comprising:
an annular tire tread including:
a tread length extending around a circumference of the tire,
a tread thickness extending in a depthwise direction from an outer, ground-engaging side, the depthwise direction being a radial direction normal to the outer, ground-engaging side and extending normal to both a tread width and the tread length, and
the tread width extending laterally in a direction transverse to the tread thickness and to a length of the tread, the width extending laterally between a first lateral side edge opposing a second lateral side edge of the tread;
a plurality of longitudinal grooves;
a plurality of intermediate tread elements offset inwardly from each of the first lateral side edge and the second lateral side edge, the plurality of intermediate tread elements consisting of all intermediate tread elements arranged along the tire tread, each intermediate tread element having a first lateral side and a second lateral side each arranged adjacent one of the plurality of longitudinal grooves such that the intermediate tread element is bounded between two of the plurality of longitudinal grooves,
the first lateral side extending in a direction of the tread thickness by a first lateral side angle relative to a radial reference direction;
the second lateral side extending in a direction of the tread thickness by a second lateral side angle relative to a radial reference direction,
where the tread is characterized as having an average lateral side angle equaling the average angle of all of the first and second lateral side angles for all of the plurality of intermediate tread elements along the length of the tread, the average lateral side angle being greater than or equal to 3 degrees or equal to or less than −3 degrees; and
where the average lateral side angle for each of the first lateral side and for the second lateral side is non-zero for all intermediate tread elements;
installing the first and second tires on a vehicle, the first tire being arranged in a first wheel position and the second tire being arranged in a second wheel position, the first and second wheel positions being arranged on opposing sides of the vehicle such that the first tire is installed in a left or right wheel position and the second tire is installed in the other of the left or right wheel positions and such that both first and second tires are together installed in front or rear wheel positions.

17. The method of claim 16, where the average lateral side angle of the first tire is different than the average lateral side angle of the second tire.

18. The method of claim 17, where the average lateral side angle of the first tire is substantially opposite in value than the average lateral side angle of the second tire.

19. The method of claim 16, where both the first and second tires are arranged relative to the vehicle to have a non-zero toe angle and where the vehicle is translating along an inclined road surface such that the second tire is arranged at a lower elevation relative the first tire along the inclined road surface.

20. The method of claim 19, where the non-zero toe angle is a positive toe angle.

21. The apparatus of claim 1, where the first lateral side angle and the second lateral side angle are both positive or are both negative.

22. the method of claim 16, where the average first lateral side angle and the average second lateral side angle are both positive or are both negative.
